(19) United States
(12) Patent Application Publication
(10) Pub. No.: US 2010/0170903 A1
(43) Pub. Date: Jul. 8, 2010

(54) TRASH RECEPTACLE INCLUDING AN ORNAMENTAL COVER

(76) Inventor: Michelle Kathleen Stegeby, Annandale, VA (US)

Correspondence Address: MAIER & MAIER, PLLC, 1000 DUKE STREET, ALEXANDRIA, VA, 22314, US

(21) Appl. No.: 12/348,583

(22) Filed: Jan. 5, 2009

(51) Int. Cl. B65F 1/16; B65D 51/04

(52) U.S. Cl. 220/376; 280/47.26

(57) ABSTRACT

An apparatus for receiving refuse therein may include a body portion; a first cover portion coupled to the body portion, the first cover portion has a substantially cylindrical shape; and a second cover portion hingedly coupled to the body portion using a hinge, the second cover portion has a substantially hemispherical shape, wherein the first cover portion and the second cover portion substantially resemble a helmet.

### BACKGROUND OF THE INVENTION

Residents of various neighborhoods, cities/townships and other communities may use trash receptacles to deliver their trash to a waste management organization. In one example, some waste management organizations may require residents to use a specific type of trash receptacle, which may be issued by the city/township or the waste management organization. Other communities may permit their residents to use any type of trash receptacle they choose.

In one example, the local waste management organization may collect the trash on a specific day. On such a day, the residents may place their trash receptacles near a predetermined pick-up point such as, but not limited to, a street curb or an alleyway. On such days, for example, the street may be lined with trash receptacles waiting to be emptied by the waste management company.

It may be desirable by some residents to differentiate their trash receptacle from the many other similar trash receptacles in their neighborhood. One known example may include marking the trash receptacle with the resident's address.

### BRIEF DESCRIPTION OF THE INVENTION

In one exemplary embodiment, an apparatus for receiving refuse therein may include a body portion; a first cover portion coupled to the body portion, the first cover portion has a substantially cylindrical shape; and a second cover portion hingedly coupled to the body portion using a hinge, the second cover portion has a substantially hemispherical shape, wherein the first cover portion and the second cover portion substantially resemble a helmet.

### BRIEF DESCRIPTION OF THE DRAWINGS

Advantages of embodiments of the present invention will be apparent from the following detailed description of the exemplary embodiments. The following detailed description should be considered in conjunction with the accompanying figures in which:

FIG. 1 is a front perspective view of a trash receptacle;

FIG. 2 is a side elevation view of the trash receptacle shown in FIG. 1;

FIG. 3 is a front elevation view of the trash receptacle shown in FIG. 1;

FIG. 4 is a rear elevation view of the trash receptacle shown in FIG. 1; and

FIG. 5 is a top view of the trash receptacle shown in FIG. 1.

### DETAILED DESCRIPTION OF THE INVENTION

Aspects of the present invention are disclosed in the following description and related figures directed to specific embodiments of the invention. Those skilled in the art will recognize that alternate embodiments may be devised without departing from the spirit or the scope of the claims. Additionally, well-known elements of exemplary embodiments of the invention will not be described in detail or will be omitted so as not to obscure the relevant details of the invention.

As used herein, the word “exemplary” means “serving as an example, instance or illustration.” The embodiments described herein are not limiting, but rather are exemplary only. It should be understood that the described embodiment are not necessarily to be construed as preferred or advantageous over other embodiments. Moreover, the terms “embodiments of the invention”, “embodiments” or “invention” do not require that all embodiments of the invention include the discussed feature, advantage or mode of operation.

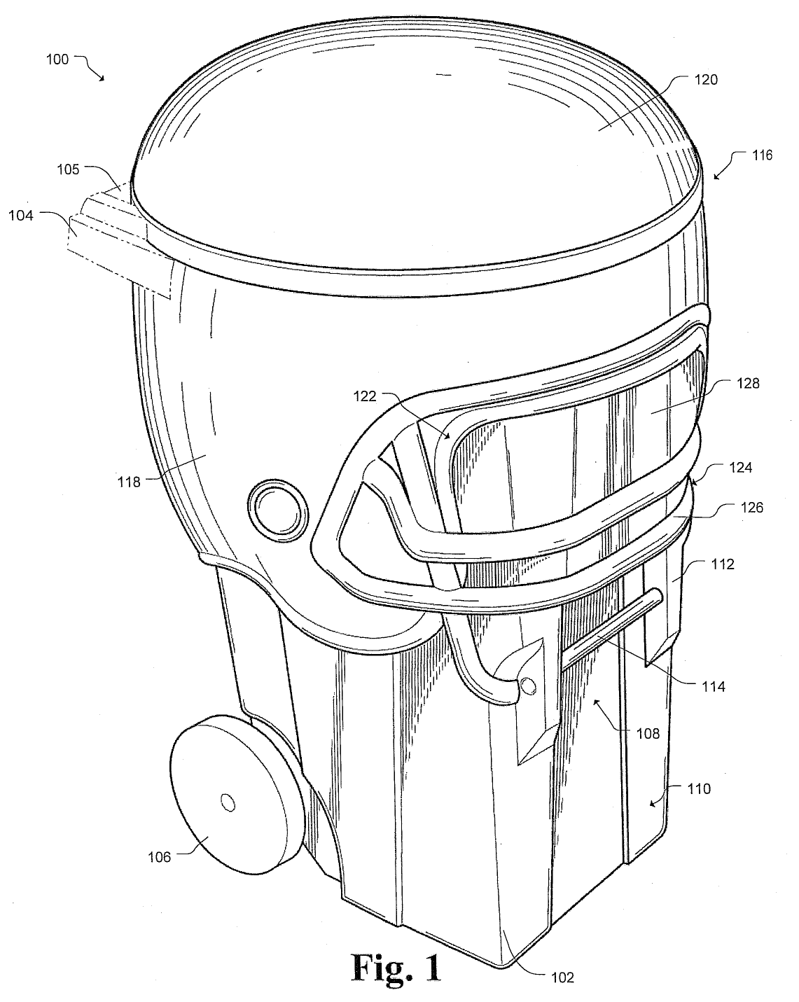

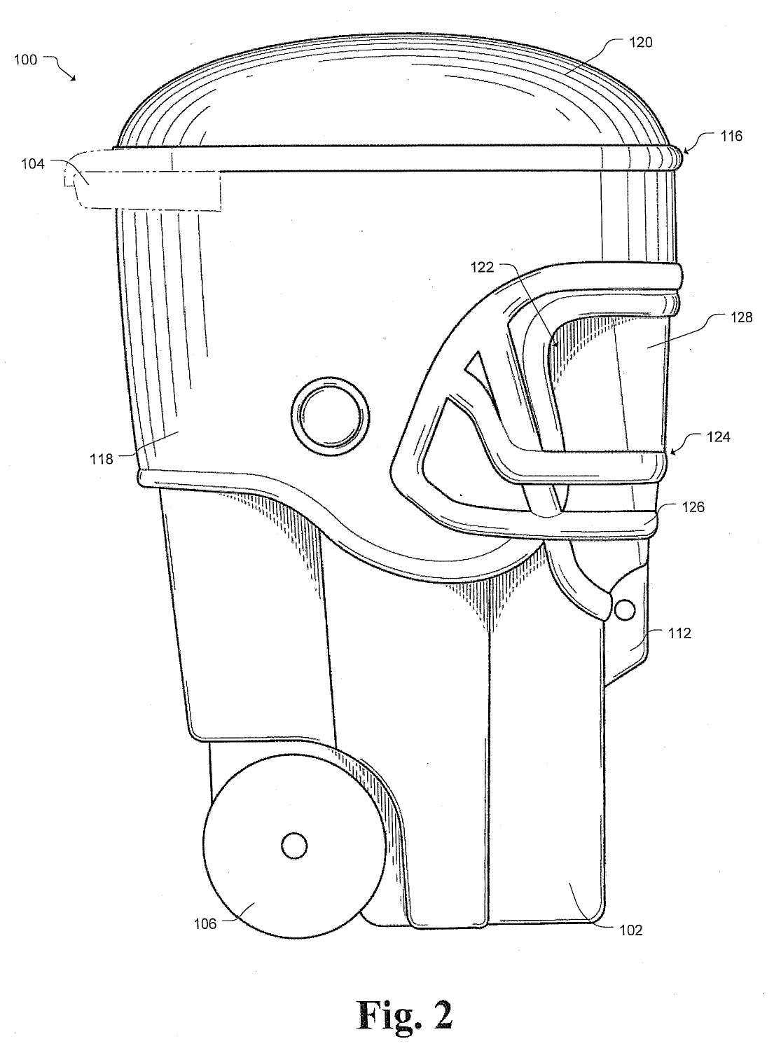

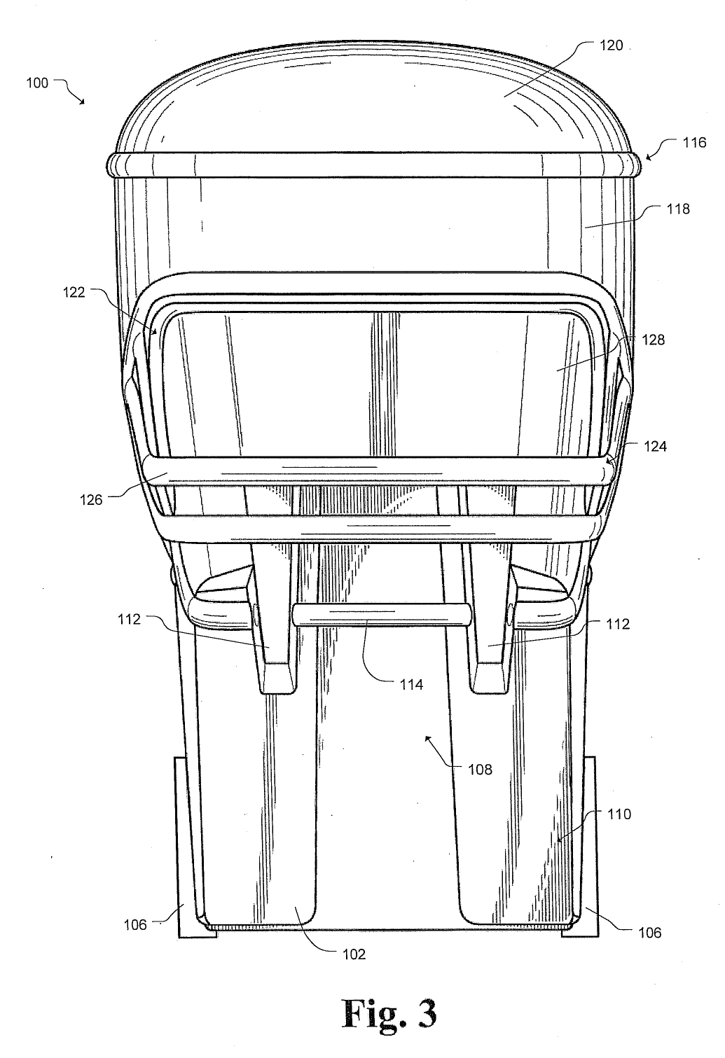

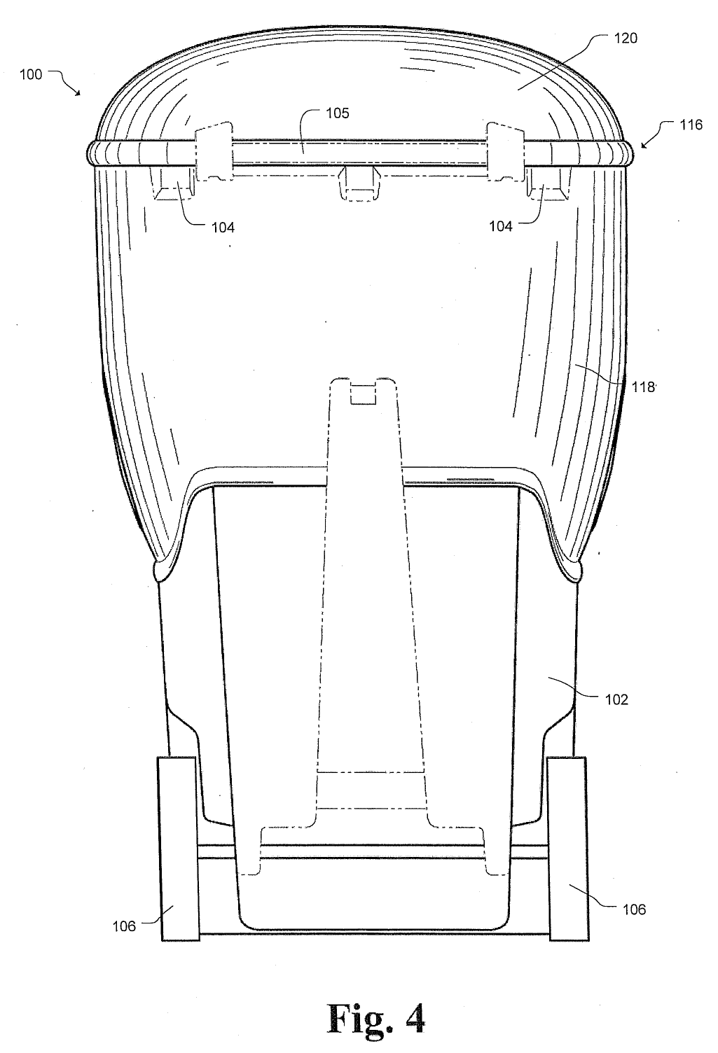

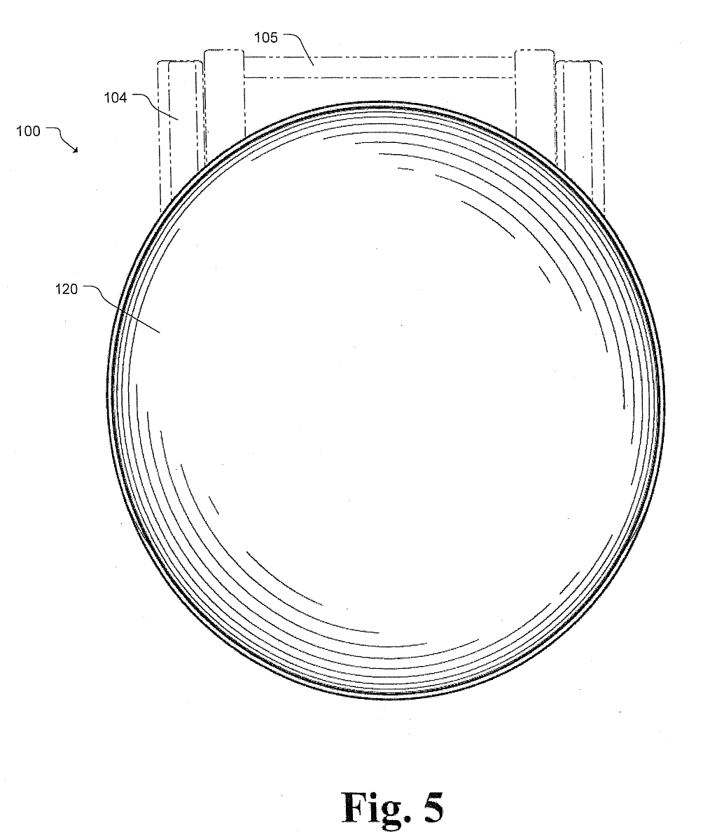

Referring to FIGS. 1-5, in the exemplary embodiment, a trash receptacle 100 is shown. Trash receptacle 100 may include a body portion 102 and a lid portion (not shown) that may be hingedly coupled to body portion 102 using a hinge 104. Trash receptacle 100 may define an internal cavity (not shown) therein that may receive trash, refuse and/or any other waste material therein. Moreover, trash receptacle 100 may include a handle 105 coupled to hinge 104 and a pair of rollers 106 that may be coupled to a bottom of body portion 102, wherein rollers 106 may facilitate transporting trash receptacle 100 short distances.

Trash receptacle 100 may be issued to a user by a local waste management company, a city/township and/or any entity that may be responsible for the removal of waste. In one embodiment, trash receptacle 100 may be designed to receive a grasping arm (not shown) of a trash removal vehicle (not shown), such as a dump truck, as described in more detail below. In the exemplary embodiment, trash receptacle 100 may include a slot 108 defined on a first, or front side 110 of body portion 102. Moreover, slot 108 may be defined by a pair of guiding members 112 that may be defined on front side 110 and that may extend away therefrom. Further, a support bar 114 may be coupled to the pair of guiding members 112 such that support bar 114 extends therebetween. Slot 108, guiding members 112 and support bar 114 may enable the grasping arm of the dump truck to grasp trash receptacle 100. As a result, the dump truck may pick up, tilt and empty the contents of trash receptacle 100 into the dump truck.

In the exemplary embodiment, trash receptacle 100 may include an ornamental cover 116 that may be coupled thereto. In the exemplary embodiment, cover 116 may include a bottom cover portion 118 and a top cover portion 120, wherein bottom cover portion 118 may be coupled to body portion 102 of trash receptacle 100, and top cover portion 120 may be coupled to the lid of trash receptacle 100. Alternatively, top cover portion 120 may substitute the lid such that top cover portion 120 may be hingedly coupled to body portion 102 of trash receptacle 100 using hinge 104, as described in more detail below.

In one embodiment, bottom cover portion 118 may be coupled to body portion 102 using a snap-fit engagement, wherein a portion of bottom cover portion may snap over hinge 104. In another embodiment, bottom cover portion 118 may be coupled to bottom cover portion 118 using any coupling means such as, but not limited to, a plurality of fasteners, an adhesive and/or any other coupling means known to a person having ordinary skill in the art that enables trash receptacle 100 to function as described herein.

In the exemplary embodiment, bottom cover portion 118 may have a substantially cylindrical shape. Moreover, bottom cover portion 118 may include a cutout 122 defined therein, which may be positioned generally adjacent front side 110 of body portion 102. In one embodiment, bottom cover portion 118 may also have a facemask portion 124 coupled thereto, wherein facemask portion 124 may be positioned substantially adjacent cutout 122. Alternatively, bottom cover portion 118 may be unitarily formed during a molding process such that facemask portion 124 is unitarily formed with bottom cover portion 118. In one embodiment, facemask portion 124 may include a plurality of bar-shaped members 126 that may generally form facemask portion 124. At least one bar-shaped member 126 may be substantially coaxial with support bar 114 such that it may appear to a user that support bar 114 is part of facemask portion 124. In one embodiment, facemask portion 124 may also include a substantially transparent visor portion 128. Alternatively, visor portion 128 may be substantially opaque. In yet another embodiment, visor portion 128 may be unitarily formed with facemask portion 124 and more specifically, bottom cover portion 118.

In the exemplary embodiment, top cover portion 120 may have a substantially hemispherical shape. As a result, top cover portion 120 may facilitate increasing the volume of the internal cavity. Moreover, when top cover portion 120 is in a substantially closed position, top cover portion 120 and bottom cover portion 118 generally form the shape of a football helmet. Alternatively, cover 116 may have a shape that substantially resembles any type of sporting helmet such as, but not limited to, a race car helmet, a motorcycle helmet, a lacrosse helmet, a hockey helmet, a baseball helmet and any other type of sporting head gear.

In the exemplary embodiment, trash receptacle 100 may be made of plastic. In one embodiment, trash receptacle 100 may be made of resin using rotational molding, blow molding and/or thermal molding. Moreover, cover 116 may also be made of plastic that may be made from a process that is substantially similar to trash receptacle 100. In one embodiment, bottom cover portion 118, top cover portion 120, facemask portion 124, bar-shaped members 126 and visor portion 128 may be unitarily formed and may be made of plastic.

In the exemplary embodiment, ornamental cover 116 may be coupled to a known trash receptacle by sliding bottom cover portion 118 over body portion 102. For example, in one embodiment, the user may remove rollers 106 such that the user may slide bottom cover portion 118 over the bottom of trash receptacle 100 towards a top of body portion 102. A portion of bottom cover portion 118 may snap over hinge 104 such that bottom cover portion 118 may be coupled to body portion 102 using a snap-fit engagement. In alternative embodiment, body portion 102 and bottom cover portion 118 may be unitarily formed as a single object during a molding process.

Top cover portion 120 may be coupled to the original lid portion of trash receptacle 100. Alternatively, the user may remove the original lid portion and hingedly couple top cover portion 120 to body portion 102 using hinge 104.

In a non-limiting example, once cover 116 is coupled to trash receptacle 100, cover 116 may substantially resemble a football helmet. The user may customize cover 116 such that cover 116 resembles any sporting team the user chooses. As a result, the user may facilitate distinguishing their particular trash receptacle 100 from the many other trash receptacles 100 in the community. Moreover, in the non-limiting example, the user may display their favorite football team's helmet using the user's trash receptacle 100. Alternatively, the user may paint cover 116 with any color or any plurality of colors to facilitate distinguishing the trash receptacle 100 from the other trash receptacles 100 in the community. In such an embodiment, cover 116 may not substantially resemble any known team but may rather be painted any color the user desires. In another embodiment, the user may further distinguish their trash receptacle 100 by adhering a sticker (not shown) to trash receptacle 100, using screen printing and/or stenciling designs to trash receptacle 100. In yet another embodiment, trash receptacle 100 may be molded with a graphic defined therein. As a result, trash receptacle 100 may be created with a distinguishing graphic such as a sports team graphic.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. An apparatus for receiving refuse therein, said apparatus comprises:
a body portion;
a first cover portion coupled to said body portion, said first cover portion has a substantially cylindrical shape; and
a second cover portion hingedly coupled to said body portion using a hinge, said second cover portion has a substantially hemispherical shape, wherein said first cover portion and said second cover portion substantially resemble a helmet.

2. An apparatus in accordance with claim 1, wherein said body portion further comprises:
a first front side;
a pair of guiding members extending away from said first front side, said pair of guiding members define a slot therebetween; and
a support bar extending between said pair of guiding members.

3. An apparatus in accordance with claim 1, wherein said first cover portion further comprises a cutout defined therein, said cutout is positioned substantially adjacent a front side of said body portion.

4. An apparatus in accordance with claim 1, wherein said first cover portion further comprises a plurality of bar-shaped members coupled thereto, said plurality of bar-shaped members substantially resemble a facemask of a sporting helmet.

5. An apparatus in accordance with claim 4, wherein said first cover portion substantially resembles a football helmet.

6. An apparatus in accordance with claim 4 further comprising a visor portion coupled to at least one bar-shaped member.

7. An apparatus in accordance with claim 2, wherein said first cover portion further comprises a plurality of bar-shaped members coupled thereto, wherein at least one bar-shaped member is substantially co-axial with said support.

8. An apparatus in accordance with claim 1 further comprises a pair of rollers coupled to a bottom of said body portion, said rollers facilitate transporting said trash receptacle.
